(19) United States
(12) Patent Application Publication
(10) Pub. No.: US 2008/0242546 A1
(43) Pub. Date: Oct. 2, 2008

(54) Synergistic herbicidal composition containing chloroacetanilides and picolinic acids

(75) Inventors: Marvin E. Schultz, Fishers, IN (US); Peter Nagy, Biot (FR); Hans U. Bernhard, Kolbermoor (DE); Pierre Daniau, Thoiry (FR)

Correspondence Address: DOW AGROSCIENCES LLC, 9330 ZIONSVILLE RD, INDIANAPOLIS, IN, 46268, US

(73) Assignee: Dow AgroSciences LLC, Indianapolis, IN (US)

(21) Appl. No.: 12/074,809

(22) Filed: Mar. 6, 2008

Related U.S. Application Data
(60) Provisional application No. 60/921,193, filed on Mar. 30, 2007.

(51) Int. Cl. A01N 43/40; A01P 13/00

(52) U.S. Cl. 504/130

(57) ABSTRACT

An herbicidal composition containing (a) an herbicidal chloroacetanilide component and (b) an herbicidal picolinic acid component provides synergistic control of selected broadleaf weeds.

### FIELD OF THE INVENTION

This application claims the benefit of U.S. Provisional Application Ser. No. 60/921,193 filed on Mar. 30, 2007. This invention concerns a synergistic herbicidal composition containing (a) an herbicidal chloroacetanilide component and (b) an herbicidal picolinic acid component.

### BACKGROUND OF THE INVENTION

The protection of crops from weeds and other vegetation which inhibit crop growth is a constantly recurring problem in agriculture. To help combat this problem, researchers in the field of synthetic chemistry have produced an extensive variety of chemicals and chemical formulations effective in the control of such unwanted growth. Chemical herbicides of many types have been disclosed in the literature and a large number are in commercial use.

In some cases, herbicidal active ingredients have been shown to be more effective in combination than when applied individually and this is referred to as “synergism.” As described in the Herbicide Handbook of the Weed Science Society of America, Seventh Edition, 1994, p. 318, “‘synergism’ [is] an interaction of two or more factors such that the effect when combined is greater than the predicted effect based on the response of each factor applied separately.” The present invention is based on the discovery that certain chloroacetanilides and certain picolinic acids, already known individually for their herbicidal efficacy, display a synergistic effect when applied in combination.

The herbicidal compounds forming the synergistic composition of this invention are independently known in the art for their effects on plant growth.

The chloroacetanilides are a known class of compounds having herbicidal activity. A number of herbicidal chloroacetanilide compounds are described in The Pesticide Manual, Fourteenth Edition, 2006, including 2-chloro-N-(ethoxymethyl)-N-(2-ethyl-6-methylphenyl)acetamide (“acetochlor”), 2-chloro-N-((2,6-diethylphenyl)-N-(methoxymethyl)acetamide (“alachlor”), N-(butoxy-methyl)-2-chloro-N-(2,6-diethylphenyl)acetamide (“butachlor”), 2-chloro-N-(2-ethyl-6-methylphenyl)-N-(2-methoxy-1-methylethyl)acetamide (“metolachlor”), 2-chloro-N-(1-methylethyl)-N-phenylacetamide (“propachlor”), 2-chloro-N-(2,4-dimethyl-3-thienyl)-N-[(1S)-2-methoxy-1-methylethyl]acetamide (“dimethenamid P”) and 2-chloro-N-(2,6-dimethylphenyl)-N-(1H-pyrazol-1-ylmethyl)acetamide (“metazachlor”). Many of these chloroacetanilide herbicides are commercially available.

The picolinic acids are also a known class of compounds having herbicidal activity. A number of picolinic acid compounds are described in The Pesticide Manual, Fourteenth Edition, 2006, including 3,6-dichloro-2-pyridinecarboxylic acid (“clopyralid”), 4-amino-3,5,6-trichloro-2-pyridinecarboxylic acid (“picloram”) and 4-amino-3,6-dichloro-2-pyridinecarboxylic acid (“aminopyralid”). Many of these picolinic acid herbicides are commercially available.

### SUMMARY OF THE INVENTION

The present invention concerns a synergistic herbicidal mixture comprising an herbicidally effective amount of (a) a chloroacetanilide compound selected from the group of acetochlor, alachlor, butachlor, dimethenamid P, metazachlor, metolachlor, propachlor and mixtures thereof and (b) a picolinic acid compound selected from the group of clopyralid, picloram, aminopyralid and mixtures thereof. The compositions may also contain an agriculturally acceptable adjuvant or carrier.

The present invention also concerns a method of controlling the growth of undesirable vegetation, particularly in crops, and the use of this synergistic composition.

The species spectrums of the compounds of the synergistic mixture, i.e., the weed species which the respective compounds control, are broad and highly complimentary. Chloroacetanilides like acetochlor control annual grass weeds and certain broadleaf weeds including Amaranthus spp and Solanum spp. Picolinic acids like clopyralid and picloram control Compositae and Amaranthaceae broadleaf weeds with some activity on Chenopodiaceae and Polygonaceae weed species. It has been surprisingly found, however, that a combination of a chloroacetanilide selected from the group of acetochlor, alachlor, butachlor, dimethenamid P, metazachlor, metolachlor, propachlor and mixtures thereof and a picolinic acid selected from the group of clopyralid, picloram, aminopyralid and mixtures thereof exhibits a synergistic action in the control of lambsquarters (chenopodium album L; CHEAL), buckwheat (polygonum convolvulus L; POLCO), knotweed (polygonum aviculare; POLAV), violet (viola arvensis L; VIOAR), cleavers (galium aparine L; GALAP), and poppy (papaver rhoeas L; PAPRH) at application rates lower than the rates of the individual compounds. Acetochlor and metazachlor are especially preferred as the chloroacetanilide and mixtures including clopyralid, picloram, and/or aminopyralid are particularly preferred as the picolinic acid. Especially preferred embodiments in which mixtures of picolinic acids are employed include: metazachlor, clopyralid and picloram; metazachlor, clopyralid, picloram and aminopyralid; and metazachlor, picloram and aminopyralid. These synergistic mixtures are particularly useful for the control of weeds in corn and oilseed rape.

### DETAILED DESCRIPTION OF THE INVENTION

The term herbicide is used herein to mean an active ingredient that kills, controls or otherwise adversely modifies the growth of plants. An herbicidally effective or vegetation controlling amount is an amount of active ingredient which causes an adversely modifying effect and includes deviations from natural development, killing, regulation, desiccation, retardation, and the like. The terms plants and vegetation include germinant seeds, emerging seedlings and established vegetation.

Herbicidal activity is exhibited by the compounds of the synergistic mixture when they are applied directly to the plant or to the locus of the plant at any stage of growth or before planting or emergence. The effect observed depends upon the plant species to be controlled, the stage of growth of the plant, the application parameters of dilution and spray drop size, the particle size of solid components, the environmental conditions at the time of use, the specific compound employed, the specific adjuvants and carriers employed, the soil type, and the like, as well as the amount of chemical applied. These and other factors can be adjusted as is known in the art to promote non-selective or selective herbicidal action. Generally, it is preferred to apply the composition of the present invention postemergence to relatively immature undesirable vegetation to achieve the maximum control of weeds.

In the composition of this invention, the weight ratio of the chloroacetanilide component to the picolinic acid component at which the herbicidal effect is synergistic lies within the range of between about 500:1 and about 6:1. Preferably the weight ratio of the chloroacetanilide component to the picolinic acid component lies within the range of between about 200:1 and about 8:1 with a weight ratio of between about 180:1 and about 11:1 being especially preferred.

The rate at which the synergistic composition is applied will depend upon the particular type of weed to be controlled, the degree of control required, and the timing and method of application. In general, the composition of the invention can be applied at an application rate of between about 0.05 kilograms per hectare (kg/ha) and about 5 kg/ha based on the total amount of active ingredients in the composition. An application rate between about 0.5 kg/ha and about 3 kg/ha is preferred. In an especially preferred embodiment of the invention, the chloroacetanilide component is applied at a rate between about 1 kg/ha and about 2 kg/ha and the picolinic acid component is applied at a rate between about 0.005 kg/ha and about 0.3 kg/ha.

The components of the synergistic mixture of the present invention can be applied either separately or as part of a multipart herbicidal system.

The synergistic mixture of the present invention can be applied in conjunction with one or more other herbicides to control a wider variety of undesirable vegetation. When used in conjunction with other herbicides, the composition can be formulated with the other herbicide or herbicides, tank mixed with the other herbicide or herbicides or applied sequentially with the other herbicide or herbicides. Some of the herbicides that can be employed in conjunction with the synergistic composition of the present invention include: amide herbicides such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides such as benzoylprop, flamprop and flamprop-M; sulfonanilide herbicides such as benzofluor, perfluidone, pyrimisulfan and profluazol; sulfonamide herbicides such as asulam, carbasulam, fenasulam and oryzalin; antibiotic herbicides such as bilanafos; benzoic acid herbicides such as chloramben, dicamba, 2,3,6-TBA and tricamba; pyrimidinyloxybenzoic acid herbicides such as bispyribac and pyriminobac; pyrimidinylthiobenzoic acid herbicides such as pyrithiobac; phthalic acid herbicides such as chlorthal; picolinic acid herbicides such as aminopyralid, clopyralid and picloram; quinolinecarboxylic acid herbicides such as quinclorac and quinmerac; arsenical herbicides such as cacodylic acid, CMA, DSMA, hexaflurate, MAA, MAMA, MSMA, potassium arsenite and sodium arsenite; benzoylcyclohexanedione herbicides such as mesotrione, sulcotrione, tefuryltrione and tembotrione; benzofuranyl alkylsulfonate herbicides such as benfuresate and ethofumesate; carbamate herbicides such as asulam, carboxazole chlorprocarb, dichlormate, fenasulam, karbutilate and terbucarb; carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides such as alloxydim, butroxydim, clethodim, cloproxydim, cycloxydim, profoxydim, sethoxydim, tepraloxydim and tralkoxydim; cyclopropylisoxazole herbicides such as isoxachlortole and isoxaflutole; dicarboximide herbicides such as benzfendizone, cinidon-ethyl, flumezin, flumiclorac, flumioxazin and flumipropyn; dinitroaniline herbicides such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides such as dinofenate, dinoprop, dinosam, dinoseb, dinoterb, DNOC, etinofen and medinoterb; diphenyl ether herbicides such as ethoxyfen; nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides such as dazomet and metam; halogenated aliphatic herbicides such as alorac, chloropon, dalapon, flupropanate, hexachloroacetone, iodomethane, methyl bromide, monochloroacetic acid, SMA and TCA; imidazolinone herbicides such as imazamethabenz, imazamox, imazapic, imazapyr, imazaquin and imazethapyr; inorganic herbicides such as ammonium sulfamate, borax, calcium chlorate, copper sulfate, ferrous sulfate, potassium azide, potassium cyanate, sodium azide, sodium chlorate and sulfuric acid; nitrile herbicides such as bromobonil, bromoxynil, chloroxynil, dichlobenil, iodobonil, ioxynil and pyraclonil; organophosphorus herbicides such as amiprofos-methyl, anilofos, bensulide, bilanafos, butamifos, 2,4-DEP, DMPA, EBEP, fosamine, glufosinate, glyphosate and piperophos; phenoxy herbicides such as bromofenoxim, clomeprop, 2,4-DEB, 2,4-DEP, difenopenten, disul, erbon, etnipromid, fenteracol and trifopsime; phenoxyacetic herbicides such as 4-CPA, 2,4-D, 3,4-DA, MCPA, MCPA-thioethyl and 2,4,5-T; phenoxybutyric herbicides such as 4-CPB, 2,4-DB, 3,4-DB, MCPB and 2,4,5-TB; phenoxypropionic herbicides such as cloprop, 4-CPP, dichlorprop, dichlorprop-P, 3,4-DP, fenoprop, mecoprop and mecoprop-P; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides such as dinitramine and prodiamine; pyrazolyl herbicides such as benzofenap, pyrazolynate, pyrasulfotole, pyrazoxyfen, pyroxasulfone and topramezone; pyrazolylphenyl herbicides such as fluazolate and pyraflufen; pyridazine herbicides such as credazine, pyridafol and pyridate; pyridazinone herbicides such as brompyrazon, chloridazon, dimidazon, flufenpyr, metflurazon, norflurazon, oxapyrazon and pydanon; pyridine herbicides such as cliodinate, dithiopyr, fluroxypyr, haloxydine, picolinafen, pyriclor, thiazopyr and triclopyr; pyrimidinediamine herbicides such as iprymidam and tioclorim; quaternary ammonium herbicides such as cyperquat, diethamquat, difenzoquat, diquat, morfamquat and paraquat; thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vemolate; thiocarbonate herbicides such as dimexano, EXD and proxan; thiourea herbicides such as methiuron; triazine herbicides such as dipropetryn, triaziflam and trihydroxytriazine; chlorotriazine herbicides such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides such as atraton, methometon, prometon, secbumeton, simeton and terbumeton; methylthiotriazine herbicides such as ametryn, aziprotryne, cyanatryn, desmetryn, dimethametryn, methoprotryne, prometryn, simetryn and terbutryn; triazinone herbicides such as ametridione, amibuzin, hexazinone, isomethiozin, metamitron and metribuzin; triazole herbicides such as amitrole, cafenstrole, epronaz and flupoxam; triazolone herbicides such as amicarbazone, bencarbazone, carfentrazone, flucarbazone, propoxycarbazone, sulfentrazone and thiencarbazone-methyl; triazolopyrimidine herbicides such as cloransulam, diclosulam, florasulam, flumetsulam, metosulam, penoxsulam and pyroxsulam; uracil herbicides such as butafenacil, bromacil, flupropacil, isocil, lenacil, saflufenacil and terbacil; 3-phenyluracils; urea herbicides such as benzthiazuron, cumyluron, cycluron, dichloralurea, diflufenzopyr, isonoruron, isouron, methabenzthiazuron, monisouron and noruron; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron and thidiazuron; pyrimidinylsulfonylurea herbicides such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron and trifloxysulfuron; triazinylsulfonylurea herbicides such as chlorsulfuron, cinosulfuron, ethametsulfuron, iodosulfuron, metsulfuron, prosulfuron, thifensulfuron, triasulfuron, tribenuron, triflusulfuron and tritosulfuron; thiadiazolylurea herbicides such as buthiuron, ethidimuron, tebuthiuron, thiazafluron and thidiazuron; and unclassified herbicides such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, flurochloridone, flurtamone, fluthiacet, indanofan, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan and tritac.

The synergistic composition of the present invention can, further, be used in conjunction with glyphosate, glufosinate, 2,4-D or dicamba on glyphosate-tolerant, glufosinate-tolerant, 2,4-D-tolerant or dicamba-tolerant crops. It is generally preferred to use the synergistic composition of the present invention in combination with herbicides that are selective for the crop being treated and which complement the spectrum of weeds controlled by these compounds at the application rate employed. It is further generally preferred to apply the synergistic composition of the present invention and other complementary herbicides at the same time, either as a combination formulation or as a tank mix.

The synergistic composition of the present invention can generally be employed in combination with known herbicide safeners, such as benoxacor, benthiocarb, brassinolide, cloquintocet (mexyl), cyometrinil, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148 and N-phenyl-sulfonylbenzoic acid amides, to enhance their selectivity.

In practice, it is preferable to use the synergistic composition of the present invention in mixtures containing an herbicidally effective amount of the herbicidal components along with at least one agriculturally acceptable adjuvant or carrier. Suitable adjuvants or carriers should not be phytotoxic to valuable crops, particularly at the concentrations employed in applying the compositions for selective weed control in the presence of crops, and should not react chemically with herbicidal components or other composition ingredients. Such mixtures can be designed for application directly to weeds or their locus or can be concentrates or formulations that are normally diluted with additional carriers and adjuvants before application. They can be solids, such as, for example, dusts, granules, water dispersible granules, or wettable powders, or liquids, such as, for example, emulsifiable concentrates, solutions, emulsions or suspensions.

Suitable agricultural adjuvants and carriers that are useful in preparing the herbicidal mixtures of the invention are well known to those skilled in the art.

Liquid carriers that can be employed include water, toluene, xylene, petroleum naphtha, crop oil, acetone, methyl ethyl ketone, cyclohexanone, trichloroethylene, perchloroethylene, ethyl acetate, amyl acetate, butyl acetate, propylene glycol monomethyl ether and diethylene glycol monomethyl ether, methanol, ethanol, isopropanol, amyl alcohol, ethylene glycol, propylene glycol, glycerine, and the like. Water is generally the carrier of choice for the dilution of concentrates.

Suitable solid carriers include talc, pyrophyllite clay, silica, attapulgus clay, kaolin clay, kieselguhr, chalk, diatomaceous earth, lime, calcium carbonate, bentonite clay, Fuller's earth, cotton seed hulls, wheat flour, soybean flour, pumice, wood flour, walnut shell flour, lignin, and the like.

It is usually desirable to incorporate one or more surface-active agents into the compositions of the present invention. Such surface-active agents are advantageously employed in both solid and liquid compositions, especially those designed to be diluted with carrier before application. The surface-active agents can be anionic, cationic or nonionic in character and can be employed as emulsifying agents, wetting agents, suspending agents, or for other purposes. Typical surface-active agents include salts of alkyl sulfates, such as diethanol-ammonium lauryl sulfate; alkylarylsulfonate salts, such as calcium dodecyl-benzenesulfonate; alkylphenol-alkylene oxide addition products, such as nonylphenol-C₁₈ ethoxylate; alcohol-alkylene oxide addition products, such as tridecyl alcohol-C₁₆ ethoxylate; soaps, such as sodium stearate; alkylnaphthalene-sulfonate salts, such as sodium dibutylnaphthalenesulfonate; dialkyl esters of sulfosuccinate salts, such as sodium di(2-ethylhexyl) sulfosuccinate; sorbitol esters, such as sorbitol oleate; quaternary amines, such as lauryl trimethyl-ammonium chloride; polyethylene glycol esters of fatty acids, such as poly-ethylene glycol stearate; block copolymers of ethylene oxide and propylene oxide; and salts of mono and dialkyl phosphate esters.

Other adjuvants commonly used in agricultural compositions include compatibilizing agents, antifoam agents, sequestering agents, neutralizing agents and buffers, corrosion inhibitors, dyes, odorants, spreading agents, penetration aids, sticking agents, dispersing agents, thickening agents, freezing point depressants, antimicrobial agents, and the like. The compositions may also contain other compatible components, for example, other herbicides, plant growth regulants, fungicides, insecticides, and the like and can be formulated with liquid fertilizers or solid, particulate fertilizer carriers such as ammonium nitrate, urea and the like.

The concentration of the active ingredients in the synergistic composition of the present invention is generally from 0.001 to 98 percent by weight. Concentrations from 0.01 to 90 percent by weight are often employed. In compositions designed to be employed as concentrates, the active ingredients are generally present in a concentration from 5 to 98 weight percent, preferably 10 to 90 weight percent. Such compositions are typically diluted with an inert carrier, such as water, before application. The diluted compositions usually applied to weeds or the locus of weeds generally contain 0.0001 to 1 weight percent active ingredient and preferably contain 0.001 to 0.05 weight percent.

The present compositions can be applied to weeds or their locus by the use of conventional ground or aerial dusters, sprayers, and granule applicators, by addition to irrigation water, and by other conventional means known to those skilled in the art.

The following examples illustrate the present invention.

### EXAMPLES

Field trials were established to evaluate weed control with herbicides applied at an early postemergence timing in field corn. Each trial was conducted as a randomized complete block design with three replications of each treatment in plots that ranged in size from 2.5×6.5 meters to 3.0×8.0 meters. Herbicide treatments in these trials included:
acetochlor at 1680 g/ha
clopyralid+picloram at 93.5+23.5 g/ha
clopyralid+picloram+aminopyralid at 72+24+12 g/ha
acetochlor+clopyralid+picloram at 1680+93.5+23.5 g/ha
acetochlor+clopyralid+picloram+aminopyralid at 1680+72+24+12 g/ha
   These herbicide treatments were broadcast sprayed postemergence over 1 to 3 leaf corn and 1 to 2 leaf weeds. The acetochlor formulation being used also contained furilazole safener.

The degree of weed control was visually evaluated and recorded at 40 to 71 days after application as a percent of weed control. Percent control is the total injury to the plants due to all factors including: stunting, malformation, chlorosis, necrosis, inhibition of emergence, and other types of plant injury. The control ratings range from 0 to 100 percent, where 0 represents no injury and 100 represents complete kill.

It was found that combinations of acetochlor in mixes with clopyralid+picloram or clopyrali +picloram+aminopyralid exhibited unexpected and surprising synergistic action in the control of CHEAL, POLAV and POLCO, while acetochlor alone, clopyralid+picloram alone, or clopyralid+picloram+aminopyralid alone did not provide acceptable control of these species.

Table 1 below shows actual results of the above described early postemergence testing of combinations of acetochlor with clopyralid+picloram on CHEAL, POLAV and POLCO. Table 1 also shows the expected weed control for the tested combinations of acetochlor with clopyralid+picloram against CHEAL, POLAV and POLCO, calculated according to the Colby method (S. R. Colby. “Calculating Synergistic and Antagonistic Response of Herbicide Combinations.” WEEDS 15(I):20-23, 1967). The Colby method represents a direct approach to measuring the synergistic activity of two herbicides. According to the Colby method:

E=X+Y−(XY/100),

wherein E is the expected percent weed control for a combination of a first herbicide H1 and a second herbicide H2 at an application rate of p+q g/ha; X is the percent weed control observed for H1 at application rate p g/ha; and Y is the percent weed control observed for H2 at application rate q g/ha.

TABLE 1
Early Post Weed Control

| | | | acetochlor + | | |
|---|---|---|---|---|---|
| | | | clopyralid + | | |
| | clopyralid + | | picloram | | |
| Weed | picloram | acetochlor | 1680 + | | |
| Bayer | 93 + 23 | 1680 | 93 + 23 | Colby | |
| Code | g ae/ha | g ai/ha | g ai, ae/ha | calculation | Difference |
| CHEAL | 53 | 47 | 98 | 76 | 22 |
| CHEAL | 70 | 52 | 99 | 85 | 14 |
| POLAV | 50 | 58 | 90 | 79 | 11 |
| POLCO | 60 | 52 | 95 | 81 | 14 |

Table 2 below shows actual results of the above described early postemergence testing of combinations of acetochlor with clopyralid+picloram+aminopyralid on CHEAL and POLAV. Table 2 also shows the expected weed control for the tested combinations of acetochlor with clopyralid+picloram+aminopyralid against CHEAL and POLAV, calculated according to the Colby method.

TABLE 2
Early Post Weed Control

| | | | acetochlor + | | |
|---|---|---|---|---|---|
| | | | clopyralid + | | |
| | clopyralid + | | picloram + | | |
| | picloram + | | aminopyralid | | |
| Weed | aminopyralid | acetochlor | 1680 + 72 + | | |
| Bayer | 72 + 24 + 12 | 1680 | 24 + 12 | Colby | |
| Code | g ae/ha | g ai/ha | g ai, ae/ha | calculation | Difference |
| CHEAL | 88 | 47 | 100 | 95 | 5 |
| POLAV | 90 | 58 | 99 | 96 | 3 |

Additional field trials were established to evaluate weed control with herbicides applied at an early postemergence timing in oilseed rape, prior to any weed emergence. Each trial was conducted as a randomized complete block design with three replications of each treatment in plots that ranged in size from 2.5×5.o meters to 3.0×6.0 meters. Herbicide treatments in these trials included:
metazachlor at 750 g/ha
clopyralid+picloram+aminopyralid at 60+20+10 g/ha
metazachlor+clopyralid+picloram+aminopyralid at 750+60+20+10 g/ha
   These herbicide treatments were broadcast sprayed postemergence over cotyledon to 1 leaf oilseed rape, but preemergence to any weeds.

The degree of weed control was visually evaluated and recorded at 55 to 68 days after application as a percent of weed control. Percent control is the total injury to the plants due to all factors including: stunting, malformation, chlorosis, necrosis, inhibition of emergence, and other types of plant injury. The control ratings range from 0 to 100 percent, where 0 represents no injury and 100 represents complete kill.

It was found that combinations of metazachlor in mixes with clopyralid+picloram+aminopyralid exhibited unexpected and surprising synergistic action in the control of VIOAR, PAPRH and GALAP, while metazachlor alone, and clopyralid+picloram+aminopyralid alone did not provide acceptable control of these species.

Table 3 below shows actual results of the above described preemergence testing of combinations of metazachlor with clopyralid+picloram+aminopyralid for control of VIOAR, PAPRH and GALAP. Table 3 also shows the expected weed control for the tested combinations of metazachlor with clopyralid+picloram+aminopyralid against VIOAR, PAPRH and GALAP, calculated according to the Colby method.

TABLE 3
Preemergence Weed Control

| | | | metazachlor + | | |
|---|---|---|---|---|---|
| | | | clopyralid + | | |
| | clopyralid + | | picloram + | | |
| | picloram + | | aminopyralid | | |
| Weed | aminopyralid | metazachlor | 750 + 60 + | Colby | |
| Bayer | 60 + 20 + 10 | 750 | 20 + 10 | cal- | Dif- |
| Code | g ae/ha | g ai/ha | g ai, ae/ha | culation | ference |
| VIOAR | 40 | 0 | 67 | 40 | 27 |
| PAPRH | 13 | 10 | 82 | 22 | 60 |
| GALAP | 47 | 53 | 87 | 75 | 12 |

The results in Tables 1, 2, and 3 demonstrate the synergistic herbicidal efficacy achieved by compositions of this invention.

Although the invention has been described with reference to preferred embodiments and examples thereof, the scope of the present invention is not limited only to those described embodiments. As will be apparent to persons skilled in the art, modifications and adaptions to the above-described invention can be made without departing from the spirit and scope of the invention, which is defined and circumscribed by the appended claims.

What is claimed is:

1. An herbicidal mixture comprising an herbicidally effective amount of (a) a chloroacetanilide compound selected from the group of acetochlor, alachlor, butachlor, dimethenamid P, metazachlor, metolachlor, propachlor and mixtures thereof and (b) a picolinic acid compound selected from the group of clopyralid, picloram, aminopyralid and mixtures thereof.

2. The mixture of claim 1 in which the chloroacetanilide compound is acetochlor or metazachlor.

3. The mixture of claim 2 in which the picolinic acid compound is a mixture of clopyralid and picloram.

4. The mixture of claim 2 in which the picolinic acid compound is a mixture of clopyralid, picloram and aminopyralid.

5. The mixture of claim 2 in which the picolinic acid compound is a mixture of picloram and aminopyralid.

6. The mixture of claim 1 in which the weight ratio of the chloroacetanilide component to the picolinic acid component is between about 500:1 and about 6:1

7. An herbicidal composition comprising an herbicidally effective amount of the herbicidal mixture of claim 1 and an agriculturally acceptable adjuvant or carrier.

8. A method of controlling undesirable vegetation which comprises contacting the vegetation or the locus thereof with or applying to the soil to prevent the emergence of vegetation an herbicidally effective amount the herbicidal mixture of claim 1.
